(19) United States
(12) Patent Application Publication
(10) Pub. No.: US 2022/0411213 A1
(43) Pub. Date: Dec. 29, 2022

(54) PAPER FEED DEVICE WITH 3D MAGNETIC SENSOR

(71) Applicant: HEWLETT-PACKARD DEVELOPMENT COMPANY, L.P., Spring, TX (US)

(72) Inventor: Yasuhiko OTAWA, Yokohama, Kanagawa (JP)

(21) Appl. No.: 17/778,093

(22) PCT Filed: Oct. 16, 2020
(86) PCT No.: PCT/US2020/055956

§ 371 Date: May 19, 2022

(30) Foreign Application Priority Data
Nov. 28, 2019 (JP) 2019-214855

(51) Int. Cl. B65H 7/04; G03G 15/00; B65H 1/14; B65H 1/12; B65H 1/04

(52) U.S. Cl. CPC B65H 7/04; G03G 15/6511; B65H 1/14; B65H 1/12; B65H 1/04; B65H 2405/324; B65H 2511/12; B65H 2403/41; B65H 2515/40; B65H 2557/61; B65H 2801/06; B65H 2553/22; B65H 2511/15

(57) ABSTRACT

An example paper feed device includes a tray to feed printing paper, a magnetic force generation element to generate a magnetic flux, a 3D magnetic sensor to detect changes in the a density of the magnetic flux generated by the magnetic force generation element in each of three axes, and a controller. The tray has a movable element that is movable in relation to the printing paper. Either the magnetic force generation element or the 3D magnetic sensor is attached to the movable element. The controller determines the position of the movable element based on a detection signal received from the 3D magnetic sensor.

### BACKGROUND

Image forming apparatuses include a paper feed device to feed printing paper. The paper feed device includes a paper feed cassette to hold a stack of printing paper, and may in some cases include a manual feed tray to enable a user to manually feed printing paper.

### BRIEF DESCRIPTION OF THE DRAWINGS

FIG. 1 is a schematic diagram of an example image forming apparatus.

FIG. 2 is a schematic diagram of a top plan view of an example manual feed tray of the example image forming apparatus.

FIG. 3 is a schematic diagram of an example permanent magnet, and a fixed 3D magnetic sensor in a 3D coordinate system, illustrating an example state wherein the fixed 3D magnetic sensor measures a density of magnetic flux generated by the moving permanent magnet.

FIG. 4A is a graph of densities of a magnetic flux measured by the 3D magnetic sensor in the X axis direction relative to the position in the X axis of the example moving permanent magnet illustrated in FIG. 3.

FIG. 4B is a graph of densities of the magnetic flux measured in the Y axis direction relative to the position of the example moving permanent magnet along the X axis.

FIG. 4C is a graph of densities of the magnetic flux measured in the Z axis direction relative to the position of the example moving permanent magnet along the X axis.

FIG. 5A is a schematic diagram of the moving permanent magnet and the fixed 3D magnetic sensor of FIG. 3, illustrating an example state where the permanent magnet has moved a given distance in the X axis direction relative to the origin, according to an example.

FIG. 5B is a graph of an angle θ relative to the position in the X axis of the permanent magnet illustrated in FIG. 5A.

FIG. 6 is a schematic diagram of the example image forming apparatus illustrating an example state where the manual feed tray is opened and side guides of the manual feed tray are spaced apart by a maximum distance.

FIG. 7 is a schematic diagram of the image forming apparatus illustrating an example state where the manual feed tray is opened and the side guides of the manual feed tray are spaced apart by a minimum distance.

FIG. 8 is a schematic diagram of the image forming apparatus illustrating an example state where the manual feed tray is closed.

FIG. 9 is a flowchart of an example operation of the image forming apparatus.

FIG. 10A is a schematic diagram of a cassette receiver portion of the example image forming apparatus, illustrating an example state in which the cassette receiver portion contains no paper feed cassette.

FIG. 10B is a schematic diagram of an example state of the cassette receiver portion, in which the cassette receiver portion has a paper feed cassette containing a maximum amount of paper.

FIG. 10C is a schematic diagram of an example state of the cassette receiver portion, in which the paper feed cassette contains half of a maximum amount of paper.

FIG. 10D is a schematic diagram of an example state of the cassette receiver portion, in which the paper feed cassette contains no paper.

FIG. 11 is a flowchart of an example operation of a controller of the example image forming apparatus, to determine a paper level in the paper feed cassette of the image forming apparatus.

### DETAILED DESCRIPTION

In the following description, with reference to the drawings, the same reference numbers are assigned to the same components or to similar components having the same function, and overlapping description is omitted.

The terms “left” and “right” represent respective directions when a drawing is viewed from the front, and they are not always in agreement with directions during actual use of a device. Scale reductions in the drawings are not always based on actual dimensions and the drawings are sometimes emphasized partially for explanation of the operations and effects of the present disclosure.

Example image forming apparatuses including a paper feed cassette and a manual feed tray will be described, in which a paper level of printing paper remaining in the paper feed cassette may be detected, in order to improve convenience for a user, and in which the size of the printing paper in the manual feed tray may be detected to control printing operations.

An example paper feed device may include a tray to feed printing paper, a magnetic force generation element, a 3-dimensional (3D) magnetic sensor, and a controller. The tray includes a movable element that is movable in relation to the printing paper. The 3D magnetic sensor detects changes in the density of magnetic flux generated by the magnetic force generation element in three axes, respectively. The controller determines the position of the movable element based on a detection signal received from the 3D magnetic sensor. Either the magnetic force generation element or the 3D magnetic sensor is attached to the movable element. The magnetic force generation element is combined with the 3D magnetic sensor to determine the three-dimensional position of the magnetic force generation element, so as to provide more flexibility as to the location where a sensor for detection is attached, and simplify the configuration for determining the position of the movable element.

According to an example, the magnetic force generation element can be a magnet. In addition, the tray may be a manual feed tray, and the movable element may include a pair of side guides mounted on the manual feed tray, so that the controller can determine a paper size based on the position of the side guides. The magnetic force generation element can be attached to the side guides.

According to examples, the manual feed tray is openably/closably attached to a housing of the image forming apparatus to be mounted with the paper feed device. The 3D magnetic sensor is attached to the housing. The controller can determine an open state or a closed state of the manual feed tray based on the detection signal. In addition, when the manual feed tray is in a closed state, the controller can prompt a user to open the manual feed tray.

According to examples, the controller can detect the densities of magnetic flux generated from the magnetic force generation element with the 3D magnetic sensor when the pair of side guides is at a first position and a second position, respectively, and can additionally determine the paper size by use of the respective detection signals generated from the 3D magnetic sensor.

According to examples, the controller can calibrate the 3D magnetic sensor based on a temperature around the magnetic force generation element. In addition, the controller can calibrate the 3D magnetic sensor based on a difference between a stored temperature around the magnetic force generation element and the current temperature.

According to examples, the tray is a paper feed cassette, the movable element is a stack support plate disposed in the paper feed cassette, and the controller can determine a paper level in the paper feed cassette based on the position of the stack support plate.

According to examples, the magnetic force generation element can be disposed at one of a bottom of the stack support plate and a side wall of a cassette receiver portion of an image forming apparatus to be mounted with the paper feed cassette. The 3D magnetic sensor can be disposed at the other among the bottom of the stack support plate and the side wall of the cassette receiver portion of the image forming apparatus to be mounted with the paper feed cassette. In some examples, the 3D magnetic sensor is disposed to the side wall of the cassette receiver portion, and the position of the 3D magnetic sensor can correspond to a position between a maximum position and an empty position of the printing paper stacked on the stack support plate. Further, the controller can notify a user of a decrease in the paper level based on the determined paper level.

An example image forming apparatus may have a paper feed device that includes a tray to feed printing paper, a magnetic force generation element, a 3D magnetic sensor and a controller. The tray may include a movable element that is movable in relation to the printing paper. The 3D magnetic sensor may detect changes in the density of magnetic flux generated by the magnetic force generation element in three axes, respectively. The controller may determine the position of the movable element based on a detection signal received from the 3D magnetic sensor. Either one of the magnetic force generation element or the 3D magnetic sensor is attached to the movable element. This combined use of the magnetic force generation element and the 3D magnetic sensor allows the position of the magnetic force generation element, for example, to be three-dimensionally determined by the 3D magnetic sensor, and provide more freedom on the location to which a sensor for detection is attached, in addition to simplifying the configuration for determining the position.

According to examples, the magnetic force generation element can be a magnet.

Example paper feed devices for an image forming apparatus will be described.

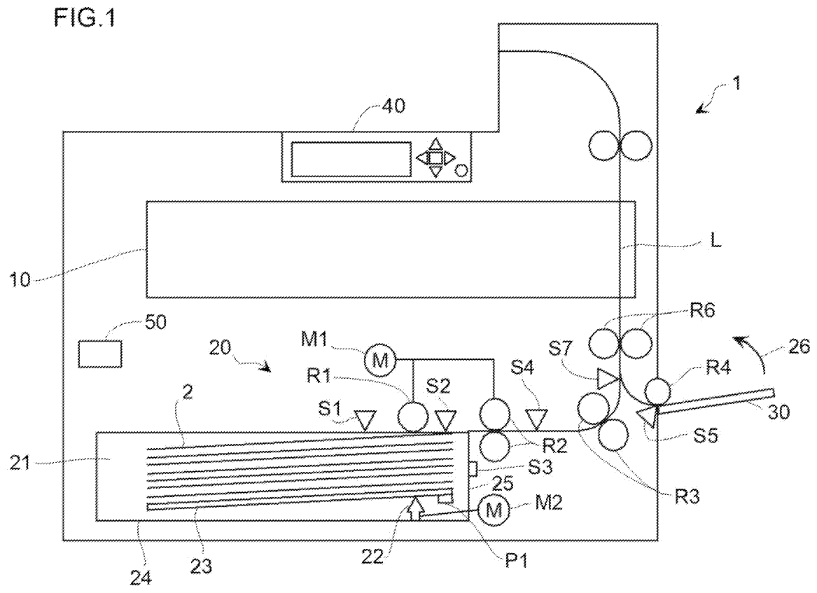

FIG. 1 schematically shows an example image forming apparatus 1 that includes: an image forming portion 10 to form an image on printing paper 2 passing through a conveyance path L, a user interface 40 to interact with a user, and a paper feed device 20 to feed the printing paper 2 to the conveyance path L. In some examples, the user interface (UI) 40 may include a button that can be pressed by the user, a display screen to display various information to the user, and a touch panel that is operable by a touch, for example with a user's finger. In addition, the image forming apparatus 1 may also include temperature sensors (e.g., thermometers) to measure an internal temperature and an external temperature, respectively.

With reference to FIG. 1, the paper feed device 20 may include a paper feed cassette 21 as a tray to accommodate a stack of printing paper 2. The paper feed cassette 21 is inserted or mounted in a cassette receiver portion 24 of the image forming apparatus 1. In this case, the image forming apparatus 1 can detect that the paper feed cassette 21 is mounted in the cassette receiver portion 24 by use of a cassette detection sensor. The paper feed cassette 21 has a stack support plate 23, on which the stack of printing paper 2 is placed, a paper elevating mechanism 22, and a paper feed roller R1. The paper elevating mechanism 22 is provided on a bottom of the stack support plate 23, to elevate (or lift) the stack support plate 23 to a position where an uppermost sheet of the printing paper 2 in the stack of the printing paper 2 reaches a predetermined height position H. Accordingly, the stack support plate 23 can be considered to be a movable element. The paper feed roller R1 can be disposed above the paper feed cassette 21 so as to contact the top of the printing paper 2 that has reached the predetermined height position H. The paper feed roller R1 can be rotated by a paper feed motor M1 to send out (or to move, or to pick-up) the uppermost sheet of the printing paper 2 in the stack of the printing paper 2 from the paper feed cassette 21.

The paper feed device 20 includes a sensor S1 to detect whether or not printing paper is present in the paper feed cassette 21. In addition, the paper feed device 20 can further include an upper limit sensor S2 to detect that the uppermost sheet of the printing paper 2 in the stack of the printing paper 2 reaches the predetermined height position H. Any suitable sensor that can detect whether or not printing paper is present in the paper feed cassette 21 can be used as the sensor S1. In addition, any suitable sensor that can detect a height position of the uppermost sheet of the printing paper 2 in the stack of the printing paper 2, can be used as the upper limit sensor S2. In some examples, the sensor S1 and the upper limit sensor S2 can include an optical sensor of transmission type or reflection type.

The paper feed device 20 can additionally include a pair of paper feed rollers R2, conveyance rollers R3 and register rollers R6. The pair of paper feed rollers R2 send out (or convey), along the conveyance path L toward the conveyance rollers R3, the printing paper 2 that has been lifted out by the paper feed roller R1. The conveyance rollers R3 convey the printing paper 2 which has been conveyed from the paper feed rollers R2, to the register rollers R6 along the conveyance path L. The register rollers R6 align the printing paper 2 and convey the printing paper 2 to the image forming portion 10. In addition, the paper feed device 20 can include an edge sensor (or tip sensor) S4 to detect whether the printing paper 2 was lifted out from the paper feed cassette 21 in accordance with a normal operation of the paper feed device 20. The edge sensor S4 can detect a edge of the printing paper 2 conveyed from the paper feed rollers R2. Additionally, the paper feed device 20 can include a sensor S7 to align the printing paper with an image. The edge sensor S4 and the sensor S7 can be, for example, an optical sensor of reflection type.

The paper elevating mechanism 22 may include any suitable mechanism or device that can move the stack of the printing paper 2 or the stack support plate 23 up and down. In some examples, the paper elevating mechanism 22 can be composed of a rack and pinion that can be driven by an elevating motor M2 and can move the stack support plate 23 up and down. In other examples, the paper elevating mechanism 22 can include a spring capable of energizing the stack support plate 23 toward the paper feed roller R1.

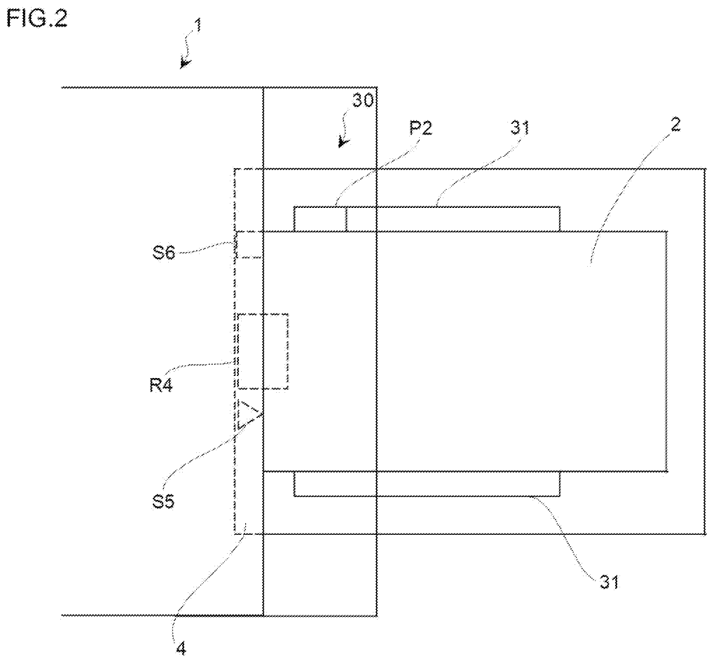

In addition, the paper feed device 20 can include a manual feed tray 30 to allow a user to perform manual paper feeding, so as to feed paper manually. The paper feed device 20 includes a paper feed roller R4 to put out (or lift out) a printing paper 2 disposed on the manual feed tray 30 and convey the printing paper 2 to the conveyance rollers R6. In addition, the paper feed device 20 includes a sensor S5 to detect whether or not printing paper is present in the manual feed tray 30. The sensor S5 may be any suitable sensor that can detect whether or not printing paper is present in the manual feed tray 30. In some examples, the sensor S5 can be an optical sensor of transmission or reflection type. The manual feed tray 30 will be further described in connection with FIG. 2.

In some examples, the paper feed device 20 is controlled by a controller 50. The controller 50 can be a microprocessor-based controller capable of connecting with a memory via, for example, a communication bus. In some examples, the controller 50 includes the memory. The memory can store machine-executable instruction, and information from various sensors attached to the image forming apparatus 1. The controller 50 can execute instructions, and can further control an operation of the image forming apparatus 1 in accordance with theses instructions. The controller 50 can be a controller to control operations of various constituent elements inside the image forming apparatus 1, or a controller dedicated to control operations of various constituent elements of the paper feed device 20.

When a user uses the manual feed tray 30 to perform printing, it may be useful to have the image forming apparatus 1 automatically detect a size or width of the printing paper 2 disposed on the manual feed tray 30, to optimize the control of toner developing and fixing in the image forming portion 10. In addition, in the image forming apparatus 1, in order to prevent printing from coming to a halt caused by use of all of the printing paper 2 in the paper feed cassette 21, it may be useful to detect a level of paper in the paper feed cassette 21 and to notify a user of it.

According to examples, a magnetic force generation element is combined with and a 3D magnetic sensor that measures a density of magnetic flux generated by the magnetic force generation element in three axes, in order to detect a size of the printing paper 2 disposed on the manual feed tray 30 and to detect a paper level of the printing paper 2 in the paper feed cassette 21.

### Detection of a Size of Printing Paper

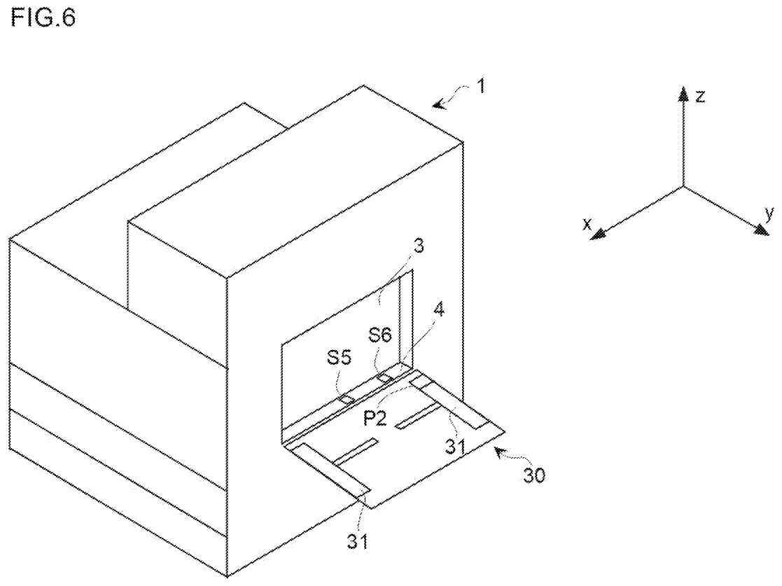

FIG. 2 is a schematic top plan view of the manual feed tray 30 attached to the image forming apparatus 1 according to an example. FIG. 2 shows a state where the printing paper 2 is disposed on the manual feed tray 30 by a user. The manual feed tray 30 is attached to the image forming apparatus 1 so as to be openable and closable as indicated by an arrow 26 in FIG. 1. Accordingly, the manual feed tray is operable between an open position (or open state) and a closed position (or closed state). The manual feed tray 30 can be opened and/or closed by the user. The manual feed tray 30 is accommodated in the manual feed tray receiver portion 3 (FIG. 6) when it is closed. The manual feed tray 30 has a pair of side guides 31 movable in accordance with a size or width of the printing paper 2. The pair of side guides 31 may cooperate to move relative to each other to suitably position the printing paper 2. Accordingly, the side guides 31 can be considered to be movable elements.

One of the pair of side guides 31 has a magnetic force generation element P2 attached thereto. In some examples, the magnetic force generation element P2 can be a permanent magnet having both surfaces magnetized. In other examples, the magnetic force generation element P2 may be an electromagnet. Hereinafter, an example in which the magnetic force generation element P2 is a permanent magnet having both surfaces magnetized will be described. In some examples, a 3D magnetic sensor S6 to measure a density of magnetic flux generated by the permanent magnet P2 in three axes is attached to a bottom surface 4 of the manual feed tray receiver portion 3 (see also FIG. 6). The position of the 3D magnetic sensor S6 can be any location where a line of magnetic force generated from the magnetic force generation element P2 can be detected. For example, the 3D magnetic sensor S6 can be an “AK09970N” (product name) commercially available from Asahi Kasei Microdevices Corporation. In other examples, the magnetic force generation element P2 may be disposed on a side surface of the image forming apparatus 1 and the 3D magnetic sensor S6 may be disposed on one of the pair of side guides 31. In addition, in some examples, the paper feed device 20 can include a temperature sensor (e.g., thermometer) to measure a temperature (e.g., an ambient temperature) around the permanent magnet P2.

The controller 50 can determine the position of the side guide 31 based on a detection signal received from the 3D magnetic sensor S6, and by extrapolation, can determine a size or width of the printing paper 2 disposed on the manual feed tray 30. The determination of this position and the size of the printing paper 2 will be further described below.

### Detection of a Paper Level in the Paper Feed Cassette

With reference to FIG. 1, according to an example of the present disclosure, a magnetic force generation element P1 can be disposed on an end of a bottom surface of the stack support plate 23 in order to detect a paper level of the printing paper 2 in the paper feed cassette 21. In some examples, the magnetic force generation element P1 can be a permanent magnet having both surfaces magnetized. In other examples, the magnetic force generation element P1 may be an electromagnet. Hereinafter, an example in which the magnetic force generation element P1 is a permanent magnet will be described. A 3D magnetic sensor S3 to measure a density of magnetic flux generated by the permanent magnet P1 in three axes can be disposed on a side wall 25 of the cassette receiver portion 24 of the image forming apparatus 1 to be mounted with the paper feed cassette 21 so as to face the stack of the printing paper 2. In some examples, the position of the 3D magnetic sensor S3 disposed on the side wall 25 can be in a space between a maximum position and an empty position of the printing paper stacked on the stack support plate. For example, the position of the 3D magnetic sensor S3 disposed on the side wall 25 can be at a height equivalent to half of the maximum position of the printing paper 2 stacked on the stack support plate 23. In another example, the magnetic force generation element P1 may be disposed on the side wall 25 and the 3D magnetic sensor may be disposed at an end of the bottom surface of the stack support plate 23. Additionally, in some examples, the paper feed device 20 can include a temperature sensor (e.g., thermometer) to measure a temperature (e.g., an ambient temperature) around the permanent magnet P1.

The controller 50 can determine the position of the stack support plate 23 as a movable element based on a detection signal received from the 3D magnetic sensor S3, and further can determine a paper level (amount of remaining printing paper) of the printing paper 2 in the paper feed cassette. The determination of this position or the paper level of the printing paper 2 in the paper feed cassette will be described further below.

### Measurement of the Position Using a 3D Magnetic Sensor

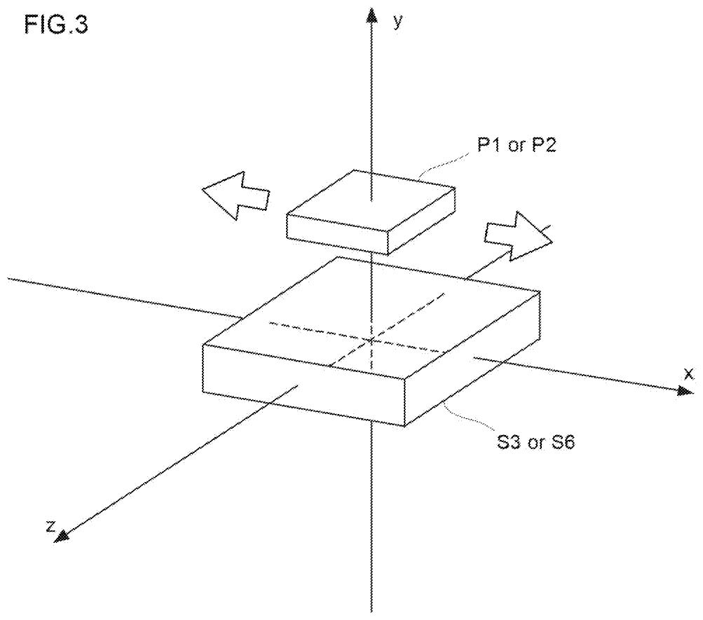

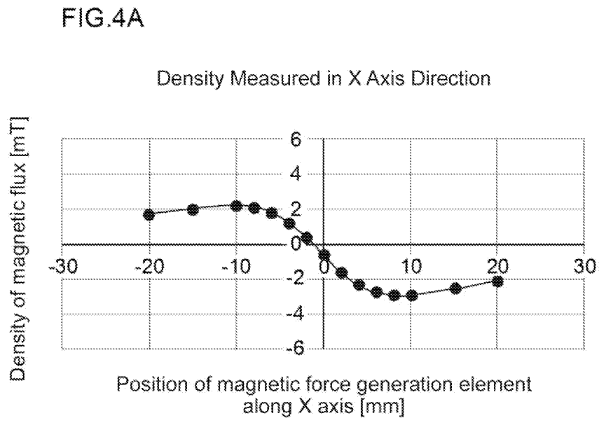

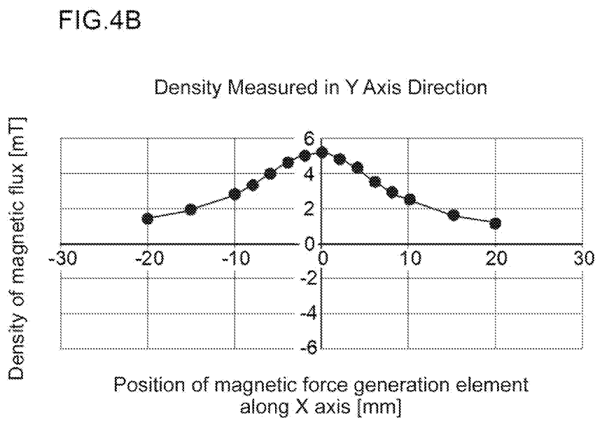

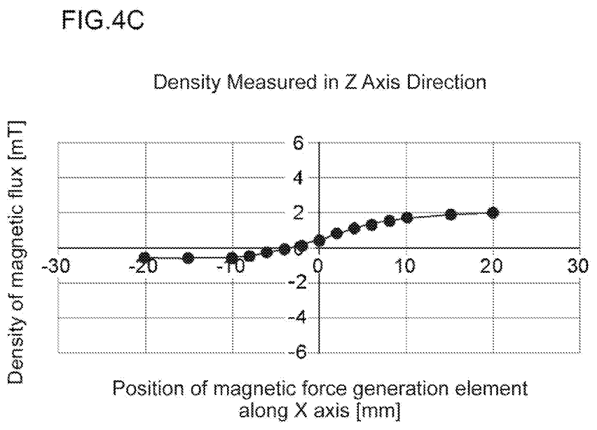

FIG. 3 schematically illustrates an example wherein the density of magnetic flux generated by the movable permanent magnet P1 or P2 is measured using the fixed 3D magnetic sensor S3 or S6. A 3D orthogonal coordinate system (or 3D Cartesian coordinate system) includes X, Y and Z axes, and the origin is positioned at the center (e.g., the center of mass) of the 3D magnetic sensor S3 or S6. The permanent magnet P1 or P2 is moved along the X axis direction. The N-pole of the permanent magnet P1 or P2 faces the 3D magnetic sensor S3 or S6. FIG. 4A to FIG. 4C show graphs, in which densities of magnetic flux measured in X axis, Y axis and Z axis directions, respectively, are plotted relative to the position of the permanent magnet P1 or P2, along the X axis according to an example.

According to the graphs of FIG. 4A and FIG. 4C, the densities of magnetic flux are almost constant or change relatively little (e.g., vary in negligible amounts) where the position of the permanent magnet P1 or P2, along the X axis exceeds the range of about ±10 mm, and accordingly, such densities measured are not suitable for detecting the position of the permanent magnet P1 or P2. For example, based on measurements of density taken in the X axis and Z axis directions exclusively, it is difficult to detect the position of the permanent magnet P1 or P2 when the position is outside the range of −10 mm to +10 mm along the X axis. In addition, the graph of FIG. 4B indicates that changes in the densities of magnetic flux are greater where the permanent magnet P1 or P2 is positioned in the range of about ±20 mm along the X axis. Accordingly, the density measurements in the Y axis direction taken where the permanent magnet P1 or P2 is positioned within the range of about ±20 mm along the X axis, are more suitable for determining the position of the permanent magnet P1 or P2. However, when detection signals of the Y axis direction are used exclusively, it is difficult to determine a movement direction of the permanent magnet P1 or P2 along the X axis, due to the symmetric shape of the curve in the graph of FIG. 4B. Accordingly, the detection signals in the X axis direction (FIG. 4A) and detection signals in the Y axis direction (FIG. 4B) may be combined to detect a position of the permanent magnet P1 or P2 in the range of −20 mm to +20 mm in the X axis direction.

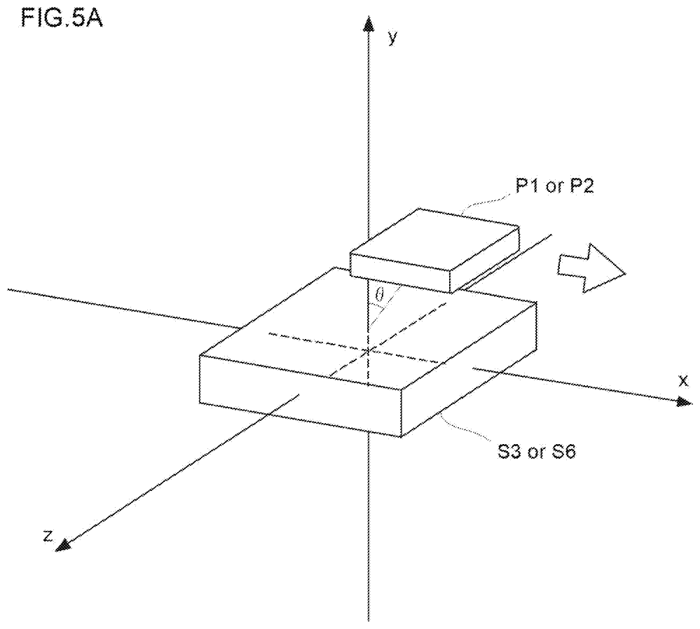

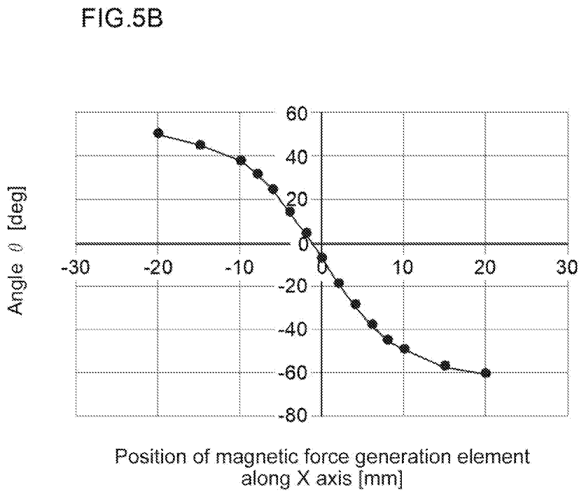

FIG. 5A schematically shows a state where the permanent magnet P1 or P2 of FIG. 3 has been moved by a given distance in the X axis direction according to an example. FIG. 5A shows an angle θ between the Y axis and a line extending from the point where the Y axis intersects a surface of the 3D magnetic sensor S3 or S6 to the center (e.g., center of mass) of the permanent magnet P1 or P2. In accordance with an example, the angle θ of the permanent magnet viewed from the D3 magnetic sensor can be calculated, for convenience, by the inverse of the tangent of the density of magnetic flux in the X axis direction divided by the density of magnetic flux in the Y axis direction, according to the equation:

θ=arctan (density of magnetic flux in the X axis direction/density of magnetic flux in the Y axis direction).

FIG. 5B is a graph showing an example relationship of the angle θ of the permanent magnet viewed from the 3D magnetic sensor S3 or S6 in the XY plane relative to the position of the permanent magnet P1 or P2 along the X axis. Accordingly, the position of the permanent magnet P1 or P2 within the range of approximately −20 mm to +20 mm along the X axis may be obtained by determining the angle θ from the detection signals in the X axis and Y axis directions from the 3D magnetic sensor S3 or S6.

With reference to FIG. 5B, the angle θ is not linear relative to the position of the X axis direction. According to examples, a linear correction may be applied to the angle θ. In some examples, such a linear correction may be performed by: 1) calculating approximate sinus values of the angle θ at multiple positions of the permanent magnet P1 or P2 along the X axis; 2) calculating approximate linear values from the maximum and minimum values of the approximate sinus values calculated; 3) calculating a difference between the linear approximate values and the approximate sinus values to obtain a difference for correction; and 4) subtracting the difference for correction from the calculated angle θ. In other examples, a table for correction on the position of the permanent magnet P1 or P2 along the X axis direction relative to the angle θ may be prepared for reference and stored in the memory of the controller 50 so that the controller 50 may correct the angle θ by referring to the table for correction.

### Calculation of the Position of the Side Guide in the Manual Feed Tray

The position of the side guide 31 in the manual feed tray 30 may be obtained based on the angle θ determined as described above. According to examples, the position of the side guides 31 may be determined from a value for the angle θ, based on values for the angle θ obtained when the side guides 31 are located at a first position and at a second position, respectively. In some examples, the position of the side guides 31 may be determined from a value for the angle θ, based on values for the angle θ obtained when the pair of side guides 31 are spaced apart by a maximum distance and when the pair of side guides 31 are spaced by a minimum distance.

FIG. 6 schematically illustrates the example image forming apparatus 1 in an example state where the manual feed tray 30 is opened. For ease of understanding, FIG. 6 is simplified by omitting the paper feed roller R4 shown in FIG. 2. In FIG. 6, the side guides 31 are spaced apart by the maximum distance. Similarly to the description with reference to FIG. 5A, it is assumed that the origin of the X axis, Y axis and Z axis of the 3D orthogonal coordinate system illustrated is positioned at the center (e.g. center of mass) of the 3D magnetic sensor S6. In this example state, a density of magnetic flux generated by the permanent magnet P2 attached to the side guide 31 may be measured in three axes by the 3D magnetic sensor S6. As described above in connection with FIG. 5A, the angle of the permanent magnet P2 viewed from the 3D magnetic sensor S6 in the XY plane can be calculated with the equation arctan (density of magnetic flux in the X axis direction/density of magnetic flux in the Y axis direction), and the calculated angle will be referred to as a magnet angle A.

FIG. 7 schematically illustrates the example image forming apparatus 1 in an example state where the manual feed tray 30 is opened. The paper feed roller R4 shown in FIG. 2 is omitted from FIG. 7. In FIG. 7, the side guides 31 are spaced apart by the minimum distance. Similarly to FIG. 5A, it is assumed that the origin of the X axis, Y axis and Z axis of the 3D orthogonal coordinate system illustrated is positioned at the center (e.g., center of mass) of the 3D magnetic sensor S6. In this example state, a density of magnetic flux generated by the permanent magnet P2 attached to the side guide 31 may be measured in three axes by the 3D magnetic sensor S6. As described above in connection with FIG. 5A, the angle of the permanent magnet P2 viewed from the 3D magnetic sensor S6 in the XY plane can be calculated with the equation arctan (density of magnetic flux in the X axis direction/density of magnetic flux in the Y axis direction), and the calculated angle will be referred to as a magnet angle B.

A factor K1 to determine the position of the side guide 31 is calculated by the following equation:

K1=(maximum width in which the side guide is movable)/(magnet angle B−magnet angle A)

In order for a user to place the printing paper 2 on the manual feed tray 30, the user can move the side guides 31 to a given position. In this state, the 3D magnetic sensor S6 may measure a density of magnetic flux generated by the permanent magnet P2 that is attached to the side guide 31. At that position, the angle θ1 of the permanent magnet P2 viewed from the 3D magnetic sensor S6 in the XY plane can be determined with the equation arctan (density of magnetic flux in the X axis direction/density of magnetic flux in the Y axis direction), as described above in connection with FIG. 5A. This angle θ1 is subject to a linear correction or the like as described above, to determine a corrected angle θ1′. The corrected angle θ1′ is referred to as a magnet angle C. The position of the side guides 31 with respect to the 3D magnetic sensor S6 is determined by the following equation.

Position of side guide=Factor K1×Magnet angle C

The determined position of the side guide 31 enables the controller 50 to grasp a width of the printing paper 2. In addition, the controller 50 measures a time period from on-state of the sensor S7 to off-state thereof, which is caused by disposing the printing paper 2 on the manual feed tray 30 and then conveying it, and can thereby determine a length of the printing paper 2.

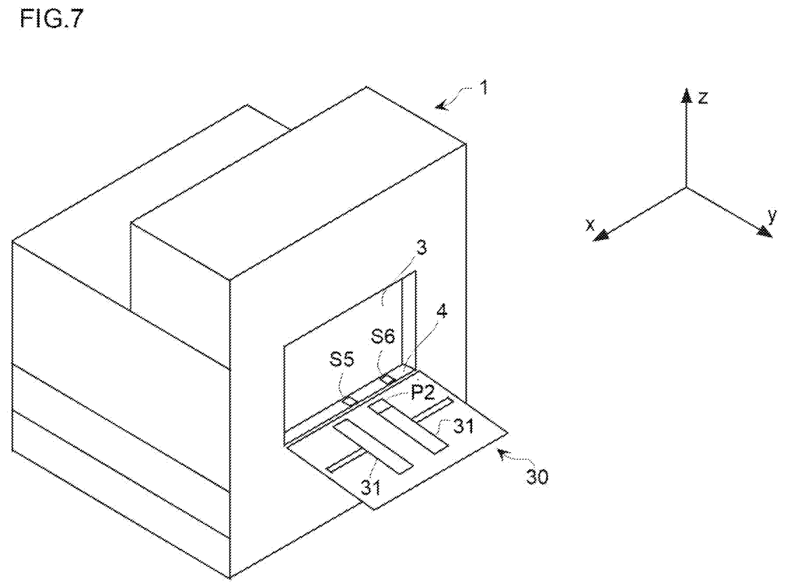

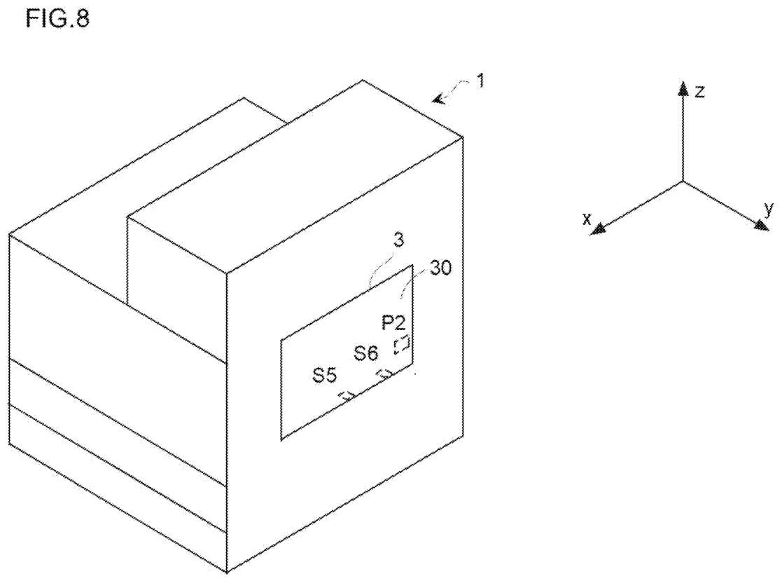

FIG. 8 schematically illustrates the example image forming apparatus 1 in an example state where the manual feed tray 30 is closed. The controller 50 can determine whether or not the side guides 31 are spaced apart in an opened position, by measuring the density of magnetic flux generated by the permanent magnet P2 attached to the side guide 31 as described above by use of the 3D magnetic sensor S6 in three axes. In this case, the controller 50 calculates an angle θ2 not in the XY plane but in the XZ plane as described above in connection with FIG. 5A. Similarly to the description with reference to FIG. 5A, it is assumed that the origin of X axis, Y axis and Z axis of the 3D orthogonal coordinate system illustrated is positioned at the center (e.g., center of mass) of the 3D magnetic sensor S6. For example, the angle θ2 of the permanent magnet P2 viewed from the 3D magnetic sensor S6 in the XZ plane can be calculated with the equation arctan (density of magnetic flux in the X axis direction/density of magnetic flux in the Z axis direction). In some examples, the controller 50 can determine that the manual feed tray 30 is closed when θ2 is within the range of −60° to +60° and the density of magnetic flux in the Y axis direction is 1 mT or less.

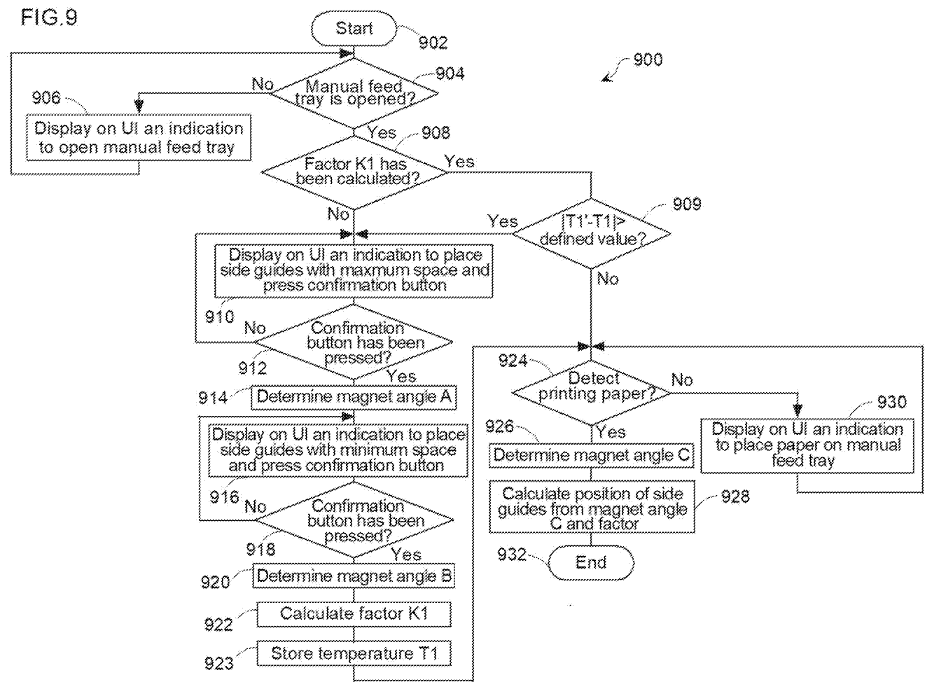

FIG. 9 is a flowchart 900 illustrating an example operation of the example image forming apparatus 1 when a user uses the manual feed tray 30 of the image forming apparatus 1. A density of magnetic flux generated by the permanent magnet P2 has temperature-dependency. In addition, results detected by the 3D magnetic sensor S6 may be also affected by environments where the image forming apparatus 1 is installed. According to the example operation illustrated in FIG. 9, the image forming apparatus 1 can calibrate influences from such temperature-dependency and environment to correctly determine the position of the side guides 31 of the manual feed tray 30.

With reference to FIG. 9, following a start of the example process at 902, at 904, the controller 50 of the image forming apparatus 1 determines whether or not the manual feed tray 30 is opened. When the manual feed tray 30 is not opened, an indication to prompt a user to open the manual feed tray 30 is displayed on the user interface (UI) 40 (at 906). When the manual feed tray 30 is opened, at 908, the controller 50 determines whether or not the factor K1 is calculated. The factor K1 is calculated at 922 described below and stored in a memory. If the factor K1 is calculated, the operation proceeds to 909. If the factor K1 is not calculated, the operation proceeds to 910. At 909, the controller 50 measures a current temperature around the permanent magnet P2 and stores it as a current temperature T1′ in the memory. In some examples, such temperature measurement can be performed by use of a temperature sensor (e.g., thermometer) disposed around the permanent magnet P2. A temperature T1 is previously stored in a memory, at 923, as described further below. The controller 50 determines whether or not |T1′−T1| is higher than a defined value (or threshold value). The defined value (or threshold value) can be within a range of 5 to 30, for example 10. When |T1′−T1| exceeds the defined value (or threshold value), the operation proceeds to 910. Otherwise, the operation proceeds to 924.

At 910, the controller 50 displays on the UI 40 an indication to prompt the user to space the side guides 31 of the manual feed tray 30 with a maximum distance and press a confirmation button. The operation proceeds to 912 where the controller 50 determines whether or not the confirmation button is pressed. If the button is not pressed, the operation returns to 910. If the button is pressed, the operation proceeds to 914. At 914, the controller 50 measures a density of magnetic flux generated by the permanent magnet P2 in the three axes by the 3D magnetic sensor S6, and calculates and stores the magnet angle A in the memory. Next, the operation proceeds to 916 where the controller 50 displays on the UI 40 an indication to prompt the user to space the side guides 31 of the manual feed tray 30 with the minimum distance and to press the confirmation button. The operation proceeds to 918 where the controller 50 determines whether or not the confirmation button is pressed. If the button is not pressed, the operation returns to 916. If the button is pressed, the operation proceeds to 920. At 920, the controller 50 measures via the 3D magnetic sensor S6 a density of magnetic flux generated by the permanent magnet P2 in the three axes, calculates the magnet angle B, and stores the magnet angle B in the memory. At 922, the controller 50 calculates the factor K1 as described above and stores the factor K1 in the memory. At 923, when calculating the factor K1, the controller 50 measures an ambient temperature around the permanent magnet P2 and stores the ambient temperature as a temperature T1 in the memory.

At 924, the controller 50 uses the sensor S5 to detect whether the printing paper 2 is disposed on the manual feed tray 30. When the paper is not disposed, the operation proceeds to 930 where the controller 50 displays on the UI 40 an indication to prompt the user to place the printing paper 2 on the manual feed tray 30. Next, the operation returns to 924. If the printing paper 2 is disposed, the operation proceeds to 926 where the controller 50 measures the density of magnetic flux generated by the permanent magnet P2 in the three axes by the 3D magnetic sensor S6 and calculates the magnet angle C through linear calibration or the like as described above. Next, the operation proceeds to 928 where the controller 50 uses the factor K1 and the magnet angle C to calculate the position of the side guides as described above, thereby determining a width of the printing paper. The operation ends at 932.

### Calculation of a Paper Level in the Paper Feed Cassette

An operation of determining the position of the stack support plate 23 in the paper feed cassette 21, that is the paper level in the paper feed cassette by using an angle θ as described above in connection with FIGS. 5A and 5B, will be described. The position of the stack support plate 23 may be determined from the value of the angle θ, by determining the values of the angle θ corresponding to a case where a maximum amount of the printing paper 2 is placed on the stack support plate 23 in the paper feed cassette 21 and a case where no printing paper 2 is present thereon.

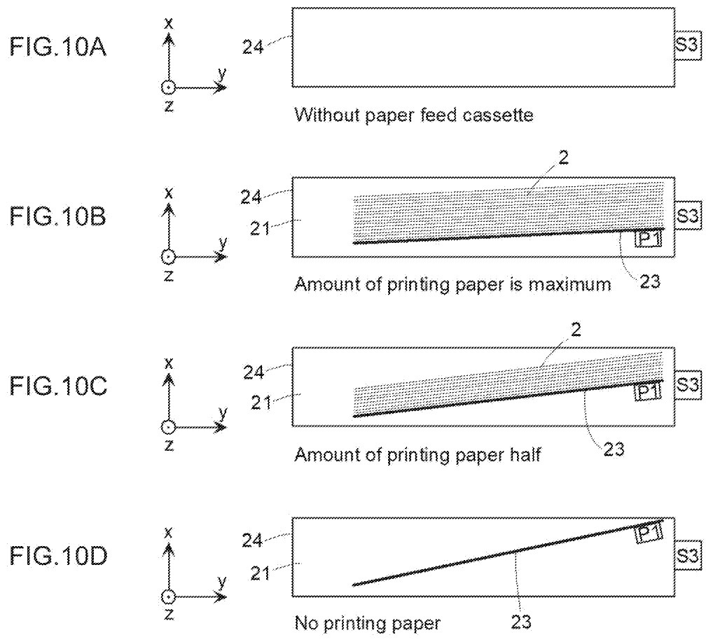

FIGS. 10A to 10D schematically illustrate example states of the paper feed cassette 21. FIG. 10A illustrates a state where the paper feed cassette 21 is not mounted in the cassette receiver portion 24 of the image forming apparatus 1. FIG. 10B illustrates a state where the paper feed cassette 21 is mounted in the cassette receiver portion 24 of the image forming apparatus 1 and an amount of the printing paper 2 placed on the stack support plate 23 in the paper feed cassette 21 is maximum (state corresponding to a maximum amount in the paper level). FIG. 10C illustrates a state where the paper feed cassette 21 is mounted in the cassette receiver portion 24 of the image forming apparatus 1 and the amount of the printing paper 2 is a half of the maximum. FIG. 10D illustrates a state where the paper feed cassette 21 is mounted in the cassette receiver portion 24 of the image forming apparatus 1 and no printing paper 2 is present. FIGS. 10A to 10D, it is assumed that the origin of X axis, Y axis and Z axis of the 3D orthogonal coordinate system illustrated is positioned at the center (e.g., center of mass) of the 3D magnetic sensor S6 in the same manner as in FIG. 5A. In some examples, when the paper feed cassette 21 is mounted in the cassette receiver portion 24 of the image forming apparatus 1, the stack support plate 23 can be elevated by the paper elevating mechanism 22 (FIG. 1) until an uppermost sheet of the printing paper 2 in the stack of the printing paper 2 reaches a predetermined height position H.

The controller 50 of the image forming apparatus 1 measures densities of magnetic flux in the three axes by the 3D magnetic sensor S3 in the state where the paper feed cassette 21 is not mounted in the cassette receiver portion 24 of the image forming apparatus 1 as shown in FIG. 10A. The controller 50 stores the densities of magnetic flux in X-axis, Y-axis and Z-axis directions in the memory as Dx, Dy and Dz, respectively. It is considered that such densities of magnetic flux Dx, Dy and Dz are derived from a magnetic field generated from an electrical component such as a motor present in the image forming apparatus, and the terrestrial magnetism. Operations to eliminate or inhibit these influences will be described.

In some examples, in the state where the paper feed cassette 21 is mounted in the cassette receiver portion 24 of the image forming apparatus 1 and an amount of the printing paper 2 placed on the stack support plate 23 in the paper feed cassette 21 is maximum as shown in FIG. 10B, the controller 50 measures densities of magnetic flux generated from the permanent magnet P1 in three axes, respectively, by use of the 3D magnetic sensor S3, and stores them as Ex, Ey and Ez in the memory. The controller 50 calculates Ex′, Ey′ and Ez′ with the equations Ex′=(Ex−Dx), Ey′=(Ey−Dy) and Ez′=(Ez−Dz), respectively, in order to eliminate or inhibit the above influences. Next, the controller 50, as described above in connection with FIG. 5A, determines a magnet angle E of the permanent magnet P1 detected by the 3D magnetic sensor S3 in the XY plane by the equation arctan (Ex′/Ey′), and stores the magnet angle E in the memory.

In some examples, in the state where the paper feed cassette 21 is mounted in the cassette receiver portion 24 of the image forming apparatus 1 and no printing paper 2 is placed in the paper feed cassette 21 as shown in FIG. 10D, the controller 50 measures densities of magnetic flux generated from the permanent magnet P1 in three axes, respectively, by use of the 3D magnetic sensor S3, and stores them as Fx, Fy and Fz in the memory. The controller 50 calculates Fx′, Fy′ and Fz′ with the equations Fx′=(Fx−Dx), Fy′=(Fy−Dy) and Fz′ =(Fz−Dz), respectively, in order to eliminate or inhibit the above influences. The controller 50, as described above in connection with FIG. 5A, determines a magnet angle F of the permanent magnet P1 viewed from the 3D magnetic sensor S3 in the XY plane, for convenience, by arctan (Fx′/Fy′), and stores the magnet angle F in the memory.

The factor K2 for acquiring the position of the stack support plate 23 in the paper feed cassette 21, that is the paper level in the paper feed cassette is calculated by the following equation:

Factor K2=(maximum of paper level)/(magnet angle F−magnet angle E)

Printing operations performed by the image forming apparatus 1 consume the printing paper 2 in the paper feed cassette 21, causing the stack support plate 23 to move to a given position. At that time, a density of magnetic flux generated by the permanent magnet P1 attached to the stack support plate 23 is measured in three axes by the 3D magnetic sensor S3. At that position, the angle θ3 of the permanent magnet P1 viewed from the 3D magnetic sensor S3 in the XY plane can be calculated as described above in connection with FIG. 5A. With respect to this angle θ3, performing linear correction or the like as described above can provide a corrected angle θ3′. The angle θ3′ will be referred to as a magnet angle G. The controller 50 determines a paper level by the following equation:

Paper level=factor K2×(magnet angle F−magnet angle G)

Based on the determined paper level, the controller 50 can notify a user of a decrease of the paper level through the user interface 40.

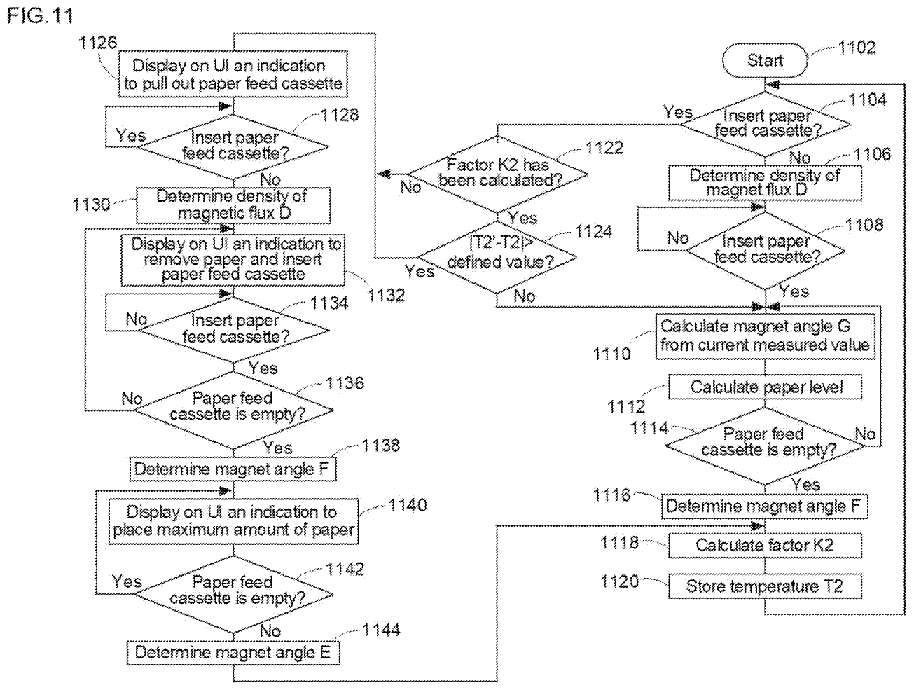

FIG. 11 is a flowchart of an example operation for determining the paper level in the paper feed cassette 21 of the example image forming apparatus 1. An ambient temperature around the permanent magnet P1 may influence the density of magnetic flux generated by the permanent magnet P1. In addition, a result detected by the 3D magnetic sensor S3 may be influenced by an environment where the image forming apparatus 1 is installed. In some examples, the image forming apparatus 1 operates in accordance with the flowchart of FIG. 11 to calibrate the temperature dependence and the environmental influence, so that the paper level in the paper feed cassette 21 can be determined more accurately or more precisely.

With reference to FIG. 11, further to a start 1102 of the example operation, the controller 50 determines whether or not the paper feed cassette 21 is mounted or inserted in the cassette receiver portion 24 at 104. If paper feed cassette 21 is inserted, the operation proceeds to 1122; or otherwise, the operation proceeds to 1106. At 1106, the controller 50 measures respective densities of magnetic flux Dx, Dy and Dz (collectively referred to as a density of magnetic flux D) in three axes via the 3D magnetic sensor S3, and stores the measured values in the memory. At 1108, the user determines whether or not to insert the paper feed cassette 21 in the cassette receiver portion 24. If paper feed cassette 21 is inserted, the operation proceeds to 1110; or otherwise, the determination at 1108 enters a loop until the paper feed cassette 21 is inserted.

At 1122, the controller 50 determines whether or not the factor K2 is calculated. The factor K2 is calculated at 1118 described below and stored in the memory. If the factor K2 is calculated, the operation proceeds to 1124; or if factor K2 is not calculated, the operation proceeds to 1126. At 1124, the controller 50 measures a current temperature around the permanent magnet P1 and stores it as a current temperature T2′ in the memory. In some examples, such temperature measurement can be performed by use of a temperature sensor (e.g., a thermometer) placed adjacent the permanent magnet P1. The controller 50 determines an absolute value of a difference between the current temperature T2′ and a temperature T2 which is described further below. The absolute value is expressed as |T2′−T2|, and determines whether the absolute value is greater than a defined value (or threshold value). The defined value can be in the range of 5 to 30, for example 10. If |T2′−T2| exceeds the defined value, the operation proceeds to 1126. If the defined value is not exceeded, the operation proceeds to 1110.

At 1126, an indication to prompt the user to pull out the paper feed cassette 21 from the cassette receiver portion 24 is displayed on the UI 40. Next, the operation proceeds to 1128 where the controller 50 determines whether or not the paper feed cassette 21 is mounted or inserted in the cassette receiver portion 24. If the paper feed cassette 21 is not inserted, the operation proceeds to 1130; and if the paper feed cassette 21 is inserted, the determination at 1128 enters a loop until the paper feed cassette 21 is pulled out. At 1130, the controller 50 measures respective densities of magnetic flux Dx, Dy and Dz (collectively referred to as density of magnetic flux D) in three axes by use of the 3D magnetic sensor S3, and stores these measured values in the memory. The controller 50 can update the densities of magnetic flux stored in the memory whenever the density of magnetic flux D is measured. At 1132, the controller 50 displays an indication on the UI40 so as to prompt the user to remove all of the printing paper 2 from the paper feed cassette 21 (so as to make the paper feed cassette empty) and insert the paper feed cassette 21 into the cassette receiver portion 24. At 1134, the controller 50 determines whether or not the paper feed cassette 21 is inserted into the cassette receiver portion 24. If the paper feed cassette 21 is inserted, the operation proceeds to 1136; and if the paper feed cassette 21 is not inserted, the determination at 1134 enters a loop until the paper feed cassette 21 is inserted. At 1136, the controller 50 detects whether or not the printing paper 2 is present in the paper feed cassette 21, and thus whether or not the paper feed cassette is empty by use of the sensor S1. If the paper feed cassette 21 is empty, the operation proceeds to 1138; and if the paper feed cassette 21 is not empty, the operation returns to 1132. At 1138, the controller 50 measures densities of magnetic flux generated from the permanent magnet P1 in three axes, respectively, by use of the 3D magnetic sensor S3 to calculate the magnet angle F, and stores the magnet angle F in the memory. At 1140, the controller 50 displays an indication on the UI40 so as to prompt the user to place the maximum amount of the printing paper 2 on the paper feed cassette 21 and insert the paper feed cassette 21 into the cassette receiver portion 24. At 1142, the controller 50 detects again whether or not the printing paper 2 is present in the paper feed cassette 21, and thus whether or not the paper feed cassette is empty, by use of the sensor S1. If the paper feed cassette is empty, the operation returns to 1140; and if the paper feed cassette is not empty, the operation proceeds to 1144. At 1144, the controller 50 measures densities of magnetic flux generated from the permanent magnet P1 in three axes, respectively, by use of the 3D magnetic sensor S3 to calculate the magnet angle E, and stores the magnet angle E in the memory. Next, the operation proceeds to 1118.

At 1110, when the image forming apparatus 1 is used by the user, the controller 50 measures densities of magnetic flux generated from the permanent magnet P1 in three axes, respectively, by use of the 3D magnetic sensor S3, and calculates the magnet angle G from these measured values. At 1112, the controller 50 uses the factor K2, the magnet angle F and the magnet angle G to calculate a paper level in the paper feed cassette 21. The controller 50 can additionally display an indication on the UI40 so as to notify the user of the calculated paper level. At 1114, the controller 50 detects whether or not the printing paper 2 is present in the paper feed cassette 21, and thus whether or not the paper feed cassette is empty, by use of the sensor S1. If the paper feed cassette 21 is empty, the operation proceeds to 1116; and if the paper feed cassette 21 is not empty, the operation returns to 1110. At 1116, the controller 50 measures densities of magnetic flux generated from the permanent magnet P1 in three axes, respectively, by use of the 3D magnetic sensor S3 to calculate the magnet angle F, and stores magnet angle F in the memory. The controller 50 can update the magnet angle F stored in the memory with each measurement of the magnet angle F. At 1118, the controller 50 calculates the factor K2 as described above and stores the factor K2 in the memory. At 1120, the controller 50 measures a temperature around the permanent magnet P1 when the factor K2 is calculated, and stores the factor K2 as a temperature T2 in the memory. Next, the operation returns to 1104.

As described in the present disclosure, a combined use of a 3D magnetic sensor and a magnetic force generation element (for example, a permanent magnet) enables a position of, for example, the magnetic force generation element to be three-dimensionally determined by the 3D magnetic sensor. When a position of a magnetic force generation element is detected by use of a magnetic sensor that measures a density of magnetic flux in a single axis, the magnetic sensor may have to be disposed to face the magnetic force generation element. However, in examples described herein, the position of the magnetic force generation element can be three-dimensionally determined by the 3D magnetic sensor, to increase flexibility as to the position or location of the 3D magnetic sensor. For example, it is not necessary that the 3D magnetic sensor be mounted to face the magnetic force generation element. This can improve flexibility on the location where a sensor for detection should be attached, as well as to simplify the configuration to determine the position of the magnetic force generation element.

It is to be understood that not all aspects, advantages and features described herein may necessarily be achieved by, or included in, any one particular example. Indeed, having described and illustrated various examples herein, it should be apparent that other examples may be modified in arrangement and detail is omitted.

1. A paper feed device comprising:
a tray to feed printing paper, the tray having a movable element that is movable in relation to the printing paper;
a magnetic force generation element to generate a magnetic flux;
a three-dimensional (3D) magnetic sensor to detect changes in a density of the magnetic flux generated by the magnetic force generation element in each of three axes, wherein either the magnetic force generation element or the 3D magnetic sensor is attached to the movable element; and
a controller to determine the position of the movable element based on a detection signal received from the 3D magnetic sensor.

2. The paper feed device of claim 1, wherein the magnetic force generation element is a magnet.

3. The paper feed device of claim 1, wherein the tray is a manual feed tray, the movable element includes a pair of side guides of the manual feed tray, and the controller determines a paper size based on the position of the side guides.

4. The paper feed device of claim 3, wherein the magnetic force generation element is attached to one of the pair of side guides.

5. The paper feed device of claim 3,
wherein the paper feed device is mounted to an image forming apparatus having a housing,
wherein the manual feed tray of the paper feed device is attached to the housing of the image forming apparatus, wherein the manual feed tray is operable between an open state and a closed state relative to the housing, and
wherein the 3D magnetic sensor is attached to the housing,
the controller to determine an open state or a closed state of the manual feed tray based on the detection signal.

6. The paper feed device of claim 5, the controller to output a notification on a user interface that indicates to open the manual feed tray, when the manual feed tray is in the closed state.

7. The paper feed device of claim 3, wherein the controller to detect densities of magnetic flux generated from the magnetic force generation element via the 3D magnetic sensor when the pair of side guides is located at a first position and a second position, respectively, to determine the paper size by use of each detection signal from the 3D magnetic sensor.

8. The paper feed device of claim 7, the controller to calibrate the 3D magnetic sensor based on a current ambient temperature detected around the magnetic force generation element.

9. The paper feed device of claim 8, the controller to calibrate the 3D magnetic sensor based on a difference between a stored ambient temperature associated with the magnetic force generation element and the current ambient temperature.

10. The paper feed device of claim 1, wherein the tray is a paper feed cassette, and wherein the movable element is a stack support plate disposed in the paper feed cassette, the controller to determine a paper level in the paper feed cassette based on the position of the stack support plate.

11. The paper feed device of claim 10,
wherein the paper feed device is mounted on an image forming apparatus having a cassette receive portion,
wherein the magnetic force generation element is disposed at a first location among a bottom of the stack support plate and a side wall of the cassette receiver portion of the image forming apparatus, and
wherein the 3D magnetic sensor is disposed at a second location among the bottom of the stack support plate and the side wall of the cassette receiver portion of the image forming apparatus.

12. The paper feed device of claim 11,
wherein a maximum position is associated with a position of the stack support plate when the stack support plate is loaded with a maximum amount of the printing paper,
wherein an empty position is associated with a position of the stack support plate when the stack support plate has no printing paper,
wherein the 3D magnetic sensor is disposed to the side wall of the cassette receiver portion, and the position of the 3D magnetic sensor corresponds to a position between the maximum position and the empty position.

13. The paper feed device of claim 10,
the controller to output a notification via a user interface that indicates a decrease in the paper level, based on a determined paper level.

14. An image forming apparatus comprising a paper feed device, the paper feed device comprising:
a tray to feed printing paper, the tray having a movable element that is movable in relation to the printing paper;
a magnetic force generation element to generate a magnetic flux;
a 3D magnetic sensor to detect changes in a density of the magnetic flux generated by the magnetic force generation element in each of three axes, respectively wherein either the magnetic force generation element or the 3D magnetic sensor is attached to the movable element of the tray; and
a controller to determine the position of the movable element based on a detection signal received from the 3D magnetic sensor.

15. The image forming apparatus according to claim 14, wherein the magnetic force generation element is a magnet.
